(19) United States
(12) Patent Application Publication
(10) Pub. No.: US 2011/0190132 A1
(43) Pub. Date: Aug. 4, 2011

(54) HERBICIDAL METHOD

(75) Inventor: James F Petta, Corpus Christi,, TX (US)

(73) Assignee: SYNGENTA CROP PROTECTION, INC., Greensboro, NC (US)

(21) Appl. No.: 12/920,793

(22) PCT Filed: Feb. 26, 2009
(86) PCT No.: PCT/US2009/035263

§ 371 Date: Dec. 13, 2010

(30) Foreign Application Priority Data
Mar. 2, 2008 (US) 61033006

(51) Int. Cl. A01N 43/90; A01P 13/00

(52) U.S. Cl. 504/136

(57) ABSTRACT

The present invention provides an aquatic herbicidal method employing the combination of diquat and acibenzolar-S-methyl in the control of aquatic weeds.

This invention concerns a method for controlling the growth of vegetation in bodies of water. In particular, the invention relates to a method of controlling the growth of aquatic weeds with a combination of a herbicidal bipyridyldiylium salt and an adjuvant.

The removal of unwanted weeds and other vegetation is a constantly recurring problem in agriculture as well as in general residential and commercial landscaped areas. In particular, the total removal of all vegetation is desirable in several situations, for example from roads, driveways, path, patios and the like. In addition, aesthetically, it may be of interest to remove such unwanted weeds and vegetation in non-crop environments, such as gardens and parks.

To help combat these problems, researchers in the field of synthetic chemistry have produced an extensive variety of chemicals and chemical formulations effective in the control of such unwanted growth. Chemical herbicides of many types have been disclosed in the literature and a large number are in commercial use. Commercial herbicides and some that are still in development are described in ‘The Pesticide Manual’, 13th Edition, published 2003 by the British Crop Protection Council.

In some cases, herbicides have been shown to be more effective in combination than when applied individually, and this is referred to as “synergism”, since the combination demonstrates a potency or activity level exceeding that which it would be expected to have based on knowledge of the individual potencies of the components.

In addition, herbicide compositions may contain agents (adjuvants) which improve the water/pesticide suspension and facilitate the coverage of the application over the target plants. An adjuvant is “an ingredient in a (pesticide or other agrichemical) prescription, which aids or modifies the action of the principal ingredient”. Chow, “Adjuvants and Agrochemicals”, Vol. 1, CRC Press (1989).

While there are numerous chemical herbicides currently available that are effective as selective terrestrial herbicides, few agents are available for controlling the growth of aquatic vegetation in water bodies such as lakes, ponds, streams, rivers and the like. Most herbicides that are effective terrestrially are not suitable for use in aquatic environments. This may be due to the fact that the terrestrial herbicides simply will not control the aquatic vegetation, the terrestrial herbicide is not stable in an aquatic environment, or because the toxicity of the terrestrial herbicides render them unfit for use in water containing animal life.

Nonetheless, many species of undesirable aquatic vegetation may be contained or controlled by treating this vegetation with a variety of aquatic herbicides. These herbicides are often times applied by spraying them beneath the water's surface. Many of these aquatic herbicides are applied in conjunction with other herbicides or with adjuvants to improve activity against the vegetation sought to be controlled.

Although most aquatic herbicides have some type of adjuvant incorporated into the formulation, the herbicide label may suggest that additional adjuvant be added. Adjuvants used in aquatic herbicides are generally of three types—activator adjuvants, spray-modifier adjuvants, and utility-modifier adjuvants

Activator adjuvants increase the activity of the herbicide by altering the characteristics of the spray solution, the rate of herbicide uptake by the plant, or the evaporation rate.

One known aquatic herbicide is diquat (1,1′-ethylene-2,2′-bipyridyldiylium dibromide) which is a non-selective contact herbicide that functions by generating superoxide, which damages cell membranes and cytoplasm. The structure of diquat can be represented as follows:

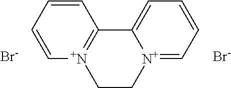

Diquat (sometimes referred to herein as diquat dibromide) is commercially available as an aqueous formulation under the trade name Reward® (Syngenta Crop Protection, Inc.).

Copper-based herbicides are used extensively in waters for control of nuisance planktonic and filamentous algal and vascular macrophyte growths. Copper that is held in an organic complex is known as chelated copper. Chelated coppers are used to control planktonic and filamentous algae. It has been found that copper sulfates and chelated copper herbicides can be mixed with diquat to better control algae as well as certain species of submerged plants.

Recently, the use of copper compounds singly or in combination with other herbicides for the control of pest aquatic vegetation has been discouraged for various reasons in certain geographies.

The compound acibenzolar-S-methyl(S-methyl benzo[1,2,3]thiadiazole-7-carbothioate) (CAS No. 135158-54-2) acts as a functional analogue of the natural signal molecule for systemic activated resistance (SAR), salicylic acid. It activates the host plant's natural defense mechanism. The structure of acibenzolar-S-methyl can be represented as follows:

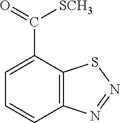

A water-dispersible granule formulation of Acibenzolar-S-methyl is commercially available under the trade name Actigard® (Syngenta Crop Protection, Inc.).

Silverman et al., in U.S. Pat. No. 6,919,298, recently reported a method of safening a crop plant against the herbicidal activity of PSI inhibitors such as paraquat, diquat and their salts comprising adding to the PSI inhibitor and effective amount of an SAR inducer.

In accordance with the present invention, it has now been discovered that the effectiveness of diquat dibromide in the control of aquatic vegetation in bodies of water is enhanced when combined with acibenzolar-S-methyl.

Accordingly, the present invention provides an aquatic herbicidal method employing the combination of diquat and acibenzolar-S-methyl in the control of aquatic weeds.

More specifically, the present invention provides a method for improving the activity of diquat in the control of aquatic weeds, which comprises, applying a herbicidally effective amount of diquat to the aquatic weeds or to their locus in the presence of a herbicidal activity improving amount of acibenzolar-S-methyl.

### BRIEF DESCRIPTION OF THE DRAWING

FIG. 1 is a chart comparing the dry weight of hydrilla 8 weeks after treatment with tank mixtures of diquat and acibenzolar-S-methyl.

Herbicidal compositions used in the method of the invention can be prepared on site by the end-user shortly before application to the foliage of the vegetation to be killed or controlled by mixing in aqueous solution a diquat dibromide containing composition, an acibenzolar-S-methyl containing composition and, optionally, a suitable surfactant or adjuvant. Such compositions are typically referred to as “tank-mix” compositions. One suitable tank mix composition can be prepared from the above-noted Reward and Actigard formulations.

Alternatively, the compositions used in the method of the invention may be provided to the end-user already formulated, either at the desired dilution for application (“ready to use” compositions) or requiring dilution, dispersion, or dissolution in water by the end-user (“concentrate” compositions). Such preformulated concentrates can be liquids or particulate solids

The composition used in the present method contains a herbicidally effective amount of a combination of diquat dibromide and acibenzolar-S-methyl. The term ‘herbicide’ as used herein denotes a compound which controls or modifies the growth of plants. The term ‘herbicidally effective amount’ indicates the quantity of such a compound or combination of such compounds which is capable of producing a controlling or modifying effect on the growth of aquatic plants. Controlling or modifying effects include all deviation from natural development, for example: killing, retardation, leaf burn, albinism, dwarfing, germination prevention and the like. For example aquatic plants that are not killed are often stunted and non-competitive with flowering disrupted. The term ‘plants’ refers to all physical parts of a plant, including seeds, seedlings, saplings, roots, tubers, stems, stalks, foliage and fruits.

The acibenzolar-S-methyl in the herbicide composition used in the present method is applied in an “activity improving amount” which indicates the quantity of such a compound that is capable of producing a statistically measurable increase in the herbicidal activity of the diquat dibromide.

As noted, the composition used in the method of the invention comprises diquat dibromide (“diquat”) and acibenzolar-S-methyl in an activity improving amount. In the compositions of this invention, the weight ratio of diquat to acibenzolar-S-methyl at which the herbicidal effect is improved lies within the range of between about 14:1 and about 1:500. Suitably, the weight ratio of diquat to acibenzolar-S-methyl is between about 14:1 and about 1:2.

In one embodiment, a suitable weight ratio of diquat to acibenzolar-S-methyl that can be applied in the control of aquatic weeds ranges from 1:10 to 1:200 and, in particular, from 1:25 to 1:100.

The rate at which the composition is applied in accordance with the method will depend upon the particular type of weed to be controlled, the degree of control required and the timing and method of application. In general, the method of the invention employs diquat at its commercially labelled rates as specified and the directions for use of the REWARD® aquatic herbicide label (e.g., 100-500 g per acre-foot of water, or from 450 to about 2,000 g per surface acre).

In another embodiment, the amount of diquat applied per liter of water in the control of aquatic weeds at a locus in accordance with the present method ranges from 1 to 500 micrograms (μg), particularly from 1 to 200 μg, more particularly from 10 to 125 μg, and most particularly from 10 to 25 μg (μG/L (ppb) of diquat dibromide (calculated as the diquat dibromide salt)).

The amount of acibenzolar-S-methyl used in the practice of the invention generally will be employed within the weight ratios specified above. In one embodiment, acibenzolar-S-methyl is employed in an amount of from 7 g to 1 kg, particularly, from 15 to 250 g, more particularly, from 15 to 60 g per acre foot of water.

Likewise, the amount of diquat used in the practice of the invention generally will be applied within the weight ratios specified above. In one embodiment, the diquat is employed to control aquatic weeds (along with acibenzolar-S-methyl) in an amount sufficient to achieve a concentration of from 1 to 400 micrograms per liter (ppb), more particularly from 190 to 370 ppb at the target locus (μg/L (ppb) of diquat dibromide (calculated as the diquat dibromide salt)).

In another embodiment, the diquat is used in an amount sufficient to achieve a concentration of from 10 to 100 ppb, more particularly from 10 to 20 ppb at the locus (μg/L (ppb) of diquat dibromide (calculated as the diquat dibromide salt)).

In another embodiment, the acibenzolar-S-methyl is employed in present method to control aquatic weeds in an amount sufficient to achieve a concentration of from 2.5 to 2000 ppb, particularly from 2.5 to 1000; or from 100 to 1000 ppb; or from 5 to 800 ppb and, more particularly, from 125 to 500 ppb, or from 125 to 250 ppb, at a locus (μg/L (ppb) of acibenzolar-S-methyl).

The method of the invention may be used against a large number of important aquatic weeds, including, but not limited to, those listed on the REWARD® aquatic herbicide label:

### Floating and Marginal Weeds Including:

Water lettuce, Pistia stratiotes
Water hyacinth, Eichhornia crassipes

### Duckweed, Lemna spp.

Salvinia spp. (including S. molesta)

### Pennywort (Hydrocotyle spp.)

Frog's Bit, Limnobium spongia

### Cattails, Typha spp.

### Submersed Weeds Including:

### Bladderwort, Utricularia spp.

Hydrilla, Hydrilla verticillata
Watermilfoils (including Eurasian), Myriophyllum spp.

### Pondweeds1, Potamogeton spp.

Coontail, Ceratophyllum demersum

### Elodea, Elodea spp.

Brazilian Elodea, Egeria densa

### Naiad, Najas spp.

### Algae, Spirogyra spp. and Pithophora spp.

Controlling means killing, damaging, or inhibiting the growth of the aquatic weeds. In one embodiment, the term “locus” is intended to include soil, seeds, and seedlings, as well as established vegetation.

The present invention is particularly useful in situations where total vegetative control is desired. In another embodiment, the term “locus” is intended to include aquatic landscapes, irrigation canals, streams, ponds, lakes, drainage ditches, impoundments, and the like. The present invention is useful for the spot treatment of weeds growing in an undesired location, or for clearing all vegetation from an aquatic environment. The herbicidal composition may be supplied in a ready-to-use format, or may be supplied in a concentrate format that requires dilution prior to application. The ready-to-use format is particularly suitable for the consumer market. The concentrate formulation may be used in either the consumer market or the professional market, as well.

The composition used in the method of the present invention is useful in controlling the growth of undesirable vegetation by pre-emergence or post-emergence application to the locus where control is desired. In one embodiment, therefore, the method of the invention contemplates a pre-emergent application. In a further embodiment, the method of the invention contemplates a post-emergent application.

In accordance with the inventive method, the compounds of the invention may be applied either simultaneously or sequentially. If administered sequentially, the components may be administered in any order in a suitable timescale, for example, with no longer than 24 hours between the time of administering the first component and the time of administering the last component. Suitably, all the components are administered within a timescale of a few hours, such as one hour. If the components are administered simultaneously, they may be administered separately or as a tank mix or as a pre-formulated mixture of all the components or as a pre-formulated mixture of some of the components tank mixed with the remaining components.

In practice, the compositions used in the method of the invention are applied as a formulation containing the various adjuvants and carriers known to or used in the industry. The compositions of the invention may thus be formulated as granules, as wettable powders, as emulsifiable concentrates, as powders or dusts, as flowables, as solutions, as suspensions or emulsions, or as controlled release forms such as microcapsules. These formulations may contain as little as about 0.5% to as much as about 95% or more by weight of active ingredient. The optimum amount for any given compound will depend on formulation, application equipment and nature of the plants to be controlled. Most suitably, the compositions used in the method of the invention are formulated as a liquid formulation to ensure good foliar uptake of acibenzolar-S-methyl and good foliar contact of diquat.

### BIOLOGICAL EXAMPLES

In the examples which follow, the μg/L (ppb) values of diquat dibromide are calculated with reference to the diquat dibromide salt and μg/L (ppb) values of Actigard are calculated with reference to the acibenzolar-S-methyl compound.

### Example 1

Initial experiments were conducted under shade house conditions. Hydrilla plants were grown from apical shoot tips in 100 liter (L) tanks and treatments of varying concentrations of Actigard (acibenzolar-S-methyl) and diquat were applied to young actively growing hydrilla in the tanks. Hydrilla plants were harvested 8 weeks after treatment (WAT) and shoot biomass was recorded. Preliminary experiments showed that tank mix combinations of Reward (diquat) at 90 ppb (¼ recommended rate) and Actigard (acibenzolar-S-methyl) at 250 ppb resulted in >90% reduction in biomass compared to untreated control. Actigard alone at 1000 ppb did not have any effect on hydrilla growth. However, there was 75% reduction in biomass with diquat treatment (90 ppb) alone in the study.

### Example 2

This study was conducted in a shade house during very active growth period of hydrilla. Plants were collected from a reservoir and experiments were conducted in a shade house (70% sunlight). Five 10 cm long sprigs of hydrilla were planted in each 25 cm pot, and then four pots were placed in each 95 L tank that contained 74 L of water. Each tank was one replication and each treatment was replicated four times. Plants were allowed to acclimate for 2 wk prior to herbicide application. This experiment was a randomized design with 4 replications (tubs). The treatments were diquat at 20 ppb alone or tank mixed with Actigard at 125, 250, 500, 1000 and 2000 ppb. All living plant tissue was harvested at the soil line 8 WAT, placed in a drying oven at 90 C for 1 week and weighed.

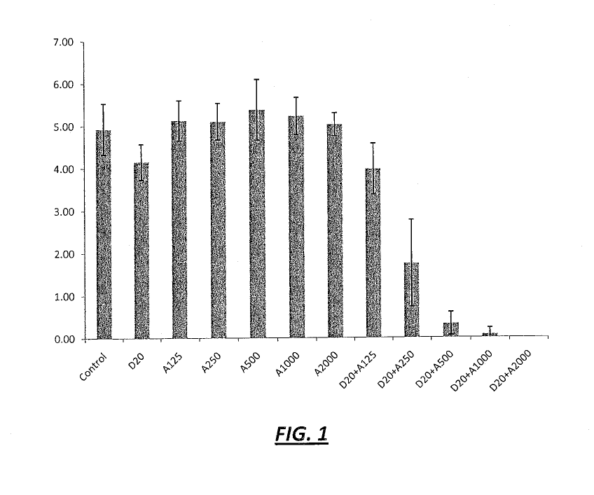

The results of this study are presented in FIG. 1, wherein: Dry weight of hydrilla 8 weeks after treatment with tank mixtures of diquat and Actigard. Diquat (D) was applied at 20 ppb and Actigard (A) rates were 125, 250, 500, 1000, or 2000 ppb. Means are presented (n=4) with error bar representing 95% confidence interval (1.96×standard error).

There was no reduction in hydrilla shoot biomass with diquat applied alone at 20 ppb compared to the control. However, addition of Actigard at 250 ppb or higher to diquat reduced hydrilla biomass significantly over the control (FIG. 1). Tank mixtures of diquat and Actigard at 20 ppb+250 ppb, 20 ppb+500 ppb, 20 ppb+1000 ppb, 20 ppb+2000 ppb resulted in 65%, 93%, 99% and 100% reduction in hydrilla shoot biomass over the control, respectively. Actigard treatments alone did not have any affect on hydrilla biomass even at the highest rate of 2000 ppb used in this study. These results showed that addition of Actigard to diquat resulted in enhanced efficacy of diquat on hydrilla compared to diquat treatments alone.

### Example 3

Study 2 was set up was similar to the previous study. Treatments consisted of diquat alone at 10 ppb or in combination with Actigard at 125, 250, 500, 1000, 2000 ppb. Shoots were harvested 14 days after treatment. The results of the study are presented in Table 1.

TABLE 1

| Herbicide Rate | Shoot biomass (% of control) |
|---|---|
| Diquat 10 ppb | 64 b* |
| Actigard 125 ppb | 99 a |
| Actigard 250 ppb | 95 a |
| Actigard 500 ppb | 93 a |
| Actigard 1000 ppb | 95 a |
| Actigard 2000 ppb | 94 a |
| Diquat 10 ppb + Actigard 125 ppb | 59 bc |
| Diquat 10 ppb + Actigard 250 ppb | 33 bc |
| Diquat 10 ppb + Actigard 500 ppb | 51 bc |
| Diquat 10 ppb + Actigard 1000 ppb | 12 c |
| Diquat 10 ppb + Actigard 2000 ppb | 27 c |
| LSD_{0.05} | 24 |

*Mean values are presented (n = 4). Means value followed by same letter are statistically similar

There was no effect on hydrilla biomass with Actigard alone at 2000 ppb. Diquat at 10 ppb caused a 37% reduction in shoot biomass compared to the control. Addition of Actigard at 250 ppb or higher resulted in 70% reduction in hydrilla shoot biomass compared to the control. The study showed that addition of Actigard at 250 ppb or higher concentrations with diquat resulted in enhanced efficacy of diquat on hydrilla compared to diquat treatment alone.

The foregoing description is for the purpose of illustration only and does not limit the scope of protection which should be accorded this invention.

1. A method for improving the activity of diquat in the control of aquatic weeds, which comprises, applying a herbicidally effective amount of diquat to the aquatic weeds or to their locus in the presence of a herbicidal activity improving amount of acibenzolar-S-methyl.

2. The method of claim 1, wherein the diquat and acibenzolar-S-methyl are applied at a weight ratio of from 14:1 to 1:2.

3. The method of claim 1, wherein the diquat and acibenzolar-S-methyl are applied at a weight ratio of from 1:10 to 1:200.

4. The method of claim 1, wherein the diquat is applied in an amount of from 1 to 400 micrograms per liter of water.

5. The method of claim 1, wherein the diquat is applied in an amount of from 10 to 100 micrograms per liter of water.

6. The method of claim 1, wherein the acibenzolar-S-methyl is applied in an amount of from 2.5 to 1000 micrograms per liter of water.

7. The method of claim 1, wherein the acibenzolar-S-methyl is applied in an amount of from 5 to 800 micrograms per liter of water.

8. The method of claim 1, wherein the aquatic weed to be controlled is selected from floating weeds and submersed weeds.

9. The method of claim 1, wherein the aquatic weed to be controlled is Hydrilla.
